(19) United States
(12) Patent Application Publication
(10) Pub. No.: US 2018/0169549 A1
(43) Pub. Date: Jun. 21, 2018

(54) FILTER ASSEMBLY WITH PRIMER

(71) Applicant: Justin Russell Pribanic, Tolland, CT (US)

(72) Inventor: Justin Russell Pribanic, Tolland, CT (US)

(73) Assignee: CLARCOR Engine Mobile Solutions, LLC, Franklin, TN (US)

(21) Appl. No.: 15/842,321

(22) Filed: Dec. 14, 2017

Related U.S. Application Data
(60) Provisional application No. 62/435,462, filed on Dec. 16, 2016.

(51) Int. Cl. B01D 35/26; F02M 37/22; F02M 37/16

(52) U.S. Cl. CPC B01D 35/26; F02M 37/22; B01D 36/001; F02M 2037/225; F02M 37/16

(57) ABSTRACT

A fuel filter assembly utilities a filter with a filter head having a primer. The primer includes a diaphragm and a valve plate which define a primer reservoir. A first check valve and a second check valve are mounted to an opening and a plurality of orifices. The first check valve consists of a ball valve. The use of a ball valve allows for an increased flow rate through the opening.

### CROSS-REFERENCE TO RELATED PATENT APPLICATION

This patent application claims the benefit of U.S. Provisional Patent Application No. 62/435,462, filed Dec. 16, 2016, the entire teachings and disclosure of which are incorporated herein by reference thereto.

### FIELD OF THE INVENTION

This invention generally relates to enhancements in devices for filtering liquids. More particularly, the present invention relates to fuel filters with primer mechanisms for removing foreign particles from fuel of a fuel supply system.

### BACKGROUND OF THE INVENTION

Filter assemblies are often used in fuel supply systems in which fluid can be contaminated with abrasive particles, water, and other contaminants. Conventional fuel supply systems use filter assemblies with replaceable filter cartridges to remove these contaminants. These replaceable filter cartridges should be primed prior to use of the fuel supply system.

Conventional headers used with fuel filter assemblies use manual or automatic primer mechanisms to facilitate engine starting after installation of a new cartridge. In particular, the primer is used to force fuel through the filter cartridge and remove any trapped air. The long standing design for a header with a primer mechanism utilizes an umbrella check valve for the inlet valve. The existing use of such primer mechanisms can lead to a pressure drop and reduce flow through the filter in comparison to fuel filter assemblies which do not use primer mechanisms with umbrella check valves. That is, the structure of the umbrella check valve is restrictive, adding to the pressure drop and contributing negatively to the filter life.

Accordingly, there is a need in the art for improved filter assemblies which do not contribute as substantially to reduce the flow rate and increase the pressure drop across the filter and filter head.

This invention provides such a filter assembly. These and other advantages of the invention, as well as additional inventive features, will be apparent from the description of the invention provided herein.

### BRIEF SUMMARY OF THE INVENTION

In view of the above, embodiments of the invention provide a filter assembly with a primer. More particularly, according to a first embodiment of the present invention, a primer assembly includes a primer support body with a primer inlet and a primer outlet. An inlet check valve in the primer support body has an open position which allows flow through the primer inlet and a closed position which blocks flow through the primer inlet. An outlet check valve in the primer support body has an open position allowing flow through the primer outlet and a closed position blocking flow through the primer outlet. A diaphragm supported by the primer body defines a reservoir for fluid. The primer inlet connects to the reservoir through the inlet check valve, and the primer outlet connects to the reservoir through the outlet check valve. An actuator acts upon the diaphragm, where movement of the actuator expands and contracts the reservoir. Further, one of the inlet check valve and the outlet check valve comprises a ball valve.

According to a more particular embodiment, a ball valve provides the inlet check valve. The ball valve comprises a valve seat defining a valve opening connected to the primer inlet port. A ball cage projects axially from and surrounds the valve seat. A valve ball is seated upon the valve seat in the closed position of the inlet check valve and trapped within the ball valve by the ball cage.

According to a more particular embodiment, a spring is interposed between said actuator and said primer support body.

According to a more particular embodiment, the ball cage further comprises a plurality of retaining members.

According to a more particular embodiment, the ball cage is comprised of four retaining members.

According to a more particular embodiment, the retaining members meet at a ring above the valve seat.

According to a more particular embodiment, the valve ball is made of one of buna-nitrile, Dupont Viton®, or polypropylene.

According to a more particular embodiment, the outlet check valve is sealed by a sealing member.

According to a more particular embodiment, the valve seat and the sealing member are a monolithic unit.

According to a more particular embodiment, the valve seat and outlet check valve are made of one of buna-nitrile or Dupont Viton®.

According to a more particular embodiment, the ball cage is comprised of a mesh material.

According to a more particular embodiment, an outlet for the outlet check valve and an inlet for the inlet check valve are defined by a valve plate.

According to a more particular embodiment, the valve plate and the ball cage are monolithic unit.

According to a more particular embodiment, the valve plate and ball cage are made of one of glass filled nylon or PBT.

According to a more particular embodiment, a counterbore is formed in the valve seat.

According to a more particular embodiment, the counterbore provides an edge against which the valve ball seats.

According to a more particular embodiment, the diaphragm has a diameter of 30 millimeters to 60 millimeters, and each of the first and second check valves define an open flow area of at least 50 square millimeters.

According to another embodiment of the present invention, a primer assembly comprises a primer support body providing a primer inlet and a primer outlet. An inlet check valve in the primer support body has an open position which allows flow through the primer inlet and a closed position which blocks flow through the primer inlet. An outlet check valve in the primer support body has an open position which allows flow through the primer outlet and a closed position which blocks flow through the primer outlet. A diaphragm is supported by the primer body and defines a reservoir for fluid. The primer inlet connects to the reservoir through the inlet check valve, and the primer outlet connects to the reservoir through the outlet check valve. An actuator acts upon the diaphragm, where movement of the actuator expands and contracts the reservoir. The diaphragm has a diameter of 30 millimeters to 60 millimeters and each of the first and second check valves define an open flow area of at least 50 square millimeters.

According to a more particular embodiment, a ball valve provides the inlet check valve. The ball valve comprises a valve seat defining a valve opening connected to the primer inlet port. A ball cage projects axially from and surrounds the valve seat. A valve ball is seated upon the valve seat in the closed position of the inlet check valve and trapped within the ball valve by the ball cage.

According to a more particular embodiment, a spring is interposed between said actuator and said primer support body.

According to a more particular embodiment, the ball cage further comprises a plurality of retaining members.

According to a more particular embodiment, the ball cage is comprised of four retaining members.

According to a more particular embodiment, the retaining members meet at a ring above the valve seat.

According to a more particular embodiment, the valve ball is made of one of buna-nitrile, Dupont Viton®, or polypropylene.

According to a more particular embodiment, the outlet check valve is sealed by a sealing member.

According to a more particular embodiment, the valve seat and the sealing member are a monolithic unit.

According to a more particular embodiment, the valve seat and outlet check valve are made of are made of one of buna-nitrile or Dupont Viton®.

According to a more particular embodiment, the ball cage is comprised of a mesh material.

According to a more particular embodiment, an outlet for the outlet check valve and an inlet for the inlet check valve are defined by a valve plate.

According to a more particular embodiment, the valve plate and the ball cage are monolithic unit.

According to a more particular embodiment, the valve plate and ball cage are made of one of glass filled nylon or PBT.

According to a more particular embodiment, a counterbore is formed in the valve seat.

According to a more particular embodiment, the counterbore provides an edge against which the valve ball seats.

According to another embodiment of the present invention, a filter head and filter assembly comprises a filter head having a filter head base which has an inlet passageway and an outlet passageway, and a filter for filtering fluid. The filter is mounted to the filter head base to receive unfiltered fluid from the inlet passageway and to return filtered fluid toward the outlet passageway. A primer assembly is coupled to the filter head base and provides a connecting passageway from the filter to the outlet passageway. A primer support body provides a primer inlet and a primer outlet, and the connecting passageway passing through the primer inlet and the primer outlet. An inlet check valve in the primer support body has an open position which allows flow through the primer inlet and a closed position which blocks flow through the primer inlet. An outlet check valve in the primer support body has an open position which allows flow through the primer outlet and a closed position which blocks flow through the primer outlet. A diaphragm is supported by the primer body and defines a reservoir for fluid. The primer inlet is connected to the reservoir through the inlet check valve, and the primer outlet is connected to the reservoir through the outlet check valve. An actuator acts upon the diaphragm, where movement of the actuator expands and contracts the reservoir. The diaphragm has a diameter of 30 millimeters to 60 millimeters and each of the first and second check valves define an open flow area of at least 50 square millimeters.

According to a more particular embodiment, a ball valve provides the inlet check valve. The ball valve comprises a valve seat defining a valve opening connected to the primer inlet port. A ball cage projects axially from and surrounds the valve seat. A valve ball is seated upon the valve seat in the closed position of the inlet check valve and trapped within the ball valve by the ball cage.

According to a more particular embodiment, a spring is interposed between said actuator and said primer support body.

According to a more particular embodiment, the ball cage further comprises a plurality of retaining members.

According to a more particular embodiment, the ball cage is comprised of four retaining members.

According to a more particular embodiment, the retaining members meet at a ring above the valve seat.

According to a more particular embodiment, the valve ball is made of one of buna-nitrile, Dupont Viton®, or polypropylene.

According to a more particular embodiment, the outlet check valve is sealed by a sealing member.

According to a more particular embodiment, the valve seat and the sealing member are a monolithic unit.

According to a more particular embodiment, the valve seat and outlet check valve are made of one of buna-nitrile or Dupont Viton®.

According to a more particular embodiment, the ball cage is comprised of a mesh material.

According to a more particular embodiment, an outlet for the outlet check valve and an inlet for the inlet check valve are defined by a valve plate.

According to a more particular embodiment, the valve plate and the ball cage are monolithic unit.

According to a more particular embodiment, the valve plate and ball cage are made of one of glass filled nylon or PBT.

According to a more particular embodiment, a counterbore is formed in the valve seat.

According to a more particular embodiment, the counterbore provides an edge against which the valve ball seats.

According to another embodiment of the present invention, a primer assembly comprises a primer support body and a primer valve mounted to primer support body. An inlet check valve is formed by the primer support body and the primer valve. The inlet check valve comprises a ball check valve. An outlet check valve is formed by the primer support body and the primer valve. The outlet check valve comprises a flapper check valve. A diaphragm is supported by the primer body and defines a variable volume reservoir for fluid. An actuator acts upon the diaphragm, where movement of the actuator in a first direction contracts a volume of the reservoir, closes the ball check valve, and opens the flapper valve. Movement of the actuator in a second direction expands the volume of the reservoir, opens the ball check valve, and closes the flapper valve,

According to a more particular embodiment, the ball check valve comprises a valve seat defining a valve opening. A ball cage projects axially from and surrounds the valve seat. A valve ball is seated upon the valve seat in the closed position of the inlet check valve and is trapped within the ball check valve by the ball cage.

According to a more particular embodiment, a spring is interposed between the actuator and primer support body.

According to a more particular embodiment, the ball cage comprises a plurality of retaining members.

According to a more particular embodiment, the ball cage is comprised of four retaining members.

According to a more particular embodiment, the retaining members meet at a ring above the valve seat.

According to a more particular embodiment, the valve ball is made of one of buna-nitrile, Dupont Viton®, or polypropylene.

According to a more particular embodiment, the outlet check valve is sealed by a sealing member.

According to a more particular embodiment, the valve seat and sealing member are a monolithic unit.

According to a more particular embodiment, the valve seat and outlet check valve are made of one of buna-nitrile or Dupont Viton®.

According to a more particular embodiment, the ball cage is comprised of a mesh material.

According to a more particular embodiment, an outlet for the outlet check valve and an inlet for the inlet check valve are defined by a valve plate.

According to a more particular embodiment, the valve plate and the ball cage are monolithic unit.

According to a more particular embodiment, the valve plate and ball cage are made of one of glass filled nylon or PBT.

According to a more particular embodiment, a counterbore is formed in the valve seat.

According to a more particular embodiment, the counterbore provides an edge against which the valve ball seats.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a cross section view of a filter assembly with a filter cartridge in combination with a filter head and primer to form an assembly in accordance with the present invention;

FIG. 2 is an enlarged cross section view of a portion of the filter assembly of FIG. 1;

FIG. 3 is an enlarged cross section view of the primer of FIG. 1;

FIG. 4 is an isometric view of the valve plate and ball valve in accordance with the primer of FIG. 3;

FIG. 5 is an isometric view of the primer sealing member in accordance with the primer of FIG. 3; and

FIG. 6 is a graph showing the improved pressure drop across a filter assembly utilizing the present invention as opposed to a filter assembly utilizing a conventional design.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

With reference to the figures wherein like numerals represent like parts throughout the several figures, a primer 12 in accordance with the present invention is depicted and therein incorporates the present invention into an embodiment designed for use in fuel filtration. However, it will be recognized that the primer can be incorporated into a wide variety of other styles of known filters for use in a wide range of environments and with other fluids.

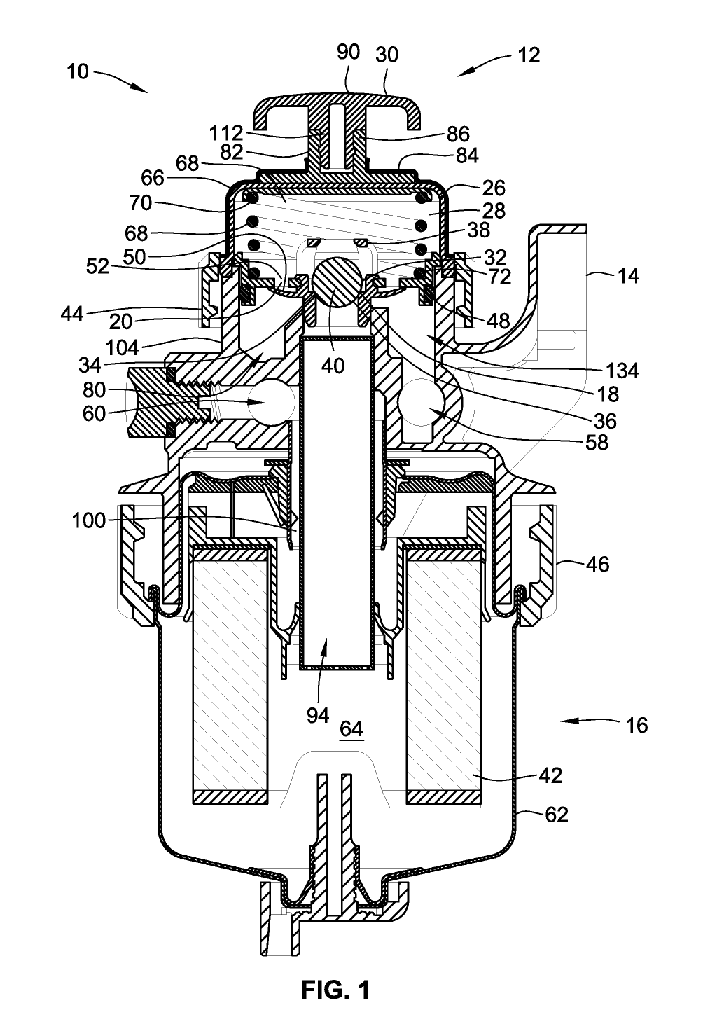

With reference to FIG. 1, a filter head 14, and a primer assembly 12 (referred to herein as a primer 12) mounted within a primer housing 66, are shown in conjunction with a filter cartridge 16 to provide a filter head and primer assembly 10. The filter head 14 is generally the component that may be permanently mounted to an engine or other fluid system, whereas the filter cartridge 16 is removably attached to the filter head 14 and may be replaced as required.

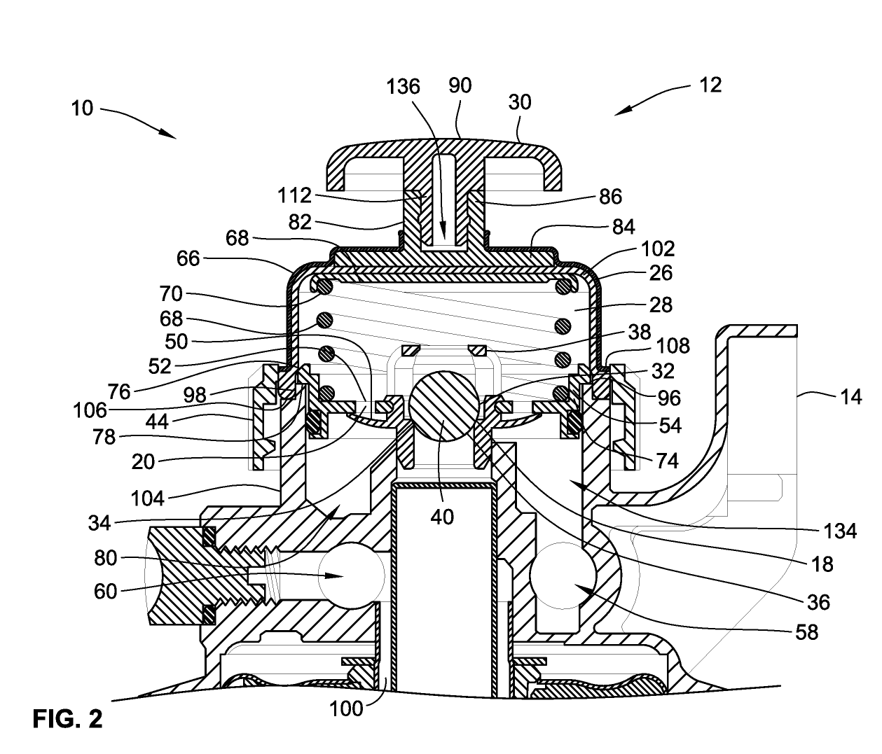

With reference to FIGS. 1-2, the primer 12 is shown mounted to the filter head 14 via a first retaining collar 44. The filter cartridge 16 includes a housing 62 and is mounted to the filter head 14 by a second retaining collar 46. The filter head 14 defines a fuel entry port 60, a fuel exit port 58, and a sump 80. The filter head 14 further includes a first fuel conduit 94 in fluid communication through the primer 12 with the fuel exit port 58 and a second fuel conduit 100 in fluid communication with the fuel entry port 60. During operation, fuel enters through the fuel entry port 60 and then the filter cartridge 16 via the second fuel conduit 100. The fuel passes through the filter element 42 and proceeds through the first fuel conduit 94, primer 12, and outlet plenum 134, then exits via the fuel exit port 58.

As shown in FIG. 1-3, the primer 12 includes a primer housing 66 that is mounted to the filter head 14. The primer housing 66 and the sump 80 define a primer reservoir 28. A diaphragm 26 is located within the primer housing 66 and has a diaphragm skirt 102 extending radially and clamped between the primer housing 66 and a rim 104 of the filter head 14. A shelf 106, defined by an upwardly projecting portion of the rim 104, and a radially flaring lower lip 108 on the primer housing 66 increase the surface contact area between the diaphragm 26, the primer housing 66, and the filter head 14. The lower lip 108 also prevents the primer housing 66 from cutting into the diaphragm skirt 102. The diaphragm is preferably made of flexible, inert material such as nitrile, fluorocarbon or flourosilicon. It will be recognized however, that other flexible materials may be used.

The primer housing 66 contains a spring 68 with an upper spring end 70 and a lower spring end 72. The spring 68 engages the lower surface of the diaphragm 26 and the upper surface of a primer support body in the form of a valve plate 74 to bias the diaphragm 26 away from the valve plate 74. A spring cap 110 may be used intermediate the upper spring end 70 and the lower surface of the diaphragm 26 to distribute the force over the surface of the diaphragm 26.

An actuator 30 of the primer 12 has a plunger 82 with a plunger base 84 disposed intermediate the upper surface of the diaphragm 26 and the end wall of the primer housing 66. A plunger shaft 86 of the plunger 82 extends upwardly through an opening 136 in the end wall of the housing and is free to move up and down within the opening 136. Plunger 82 also includes a hand knob 90 that has a stem 112 which is mounted within a blind bore 114 in the plunger shaft 86 by a circumferential protrusion 116 that is received within a groove 118 in the blind bore 114. When depressed, the hand knob 90 compresses the diaphragm 26 against the biasing force of the spring 68.

The valve plate 74 is used to direct fuel into and out of the primer reservoir 28. The previously mentioned rim 104 is received by a cylindrical portion 54 of the valve plate 74. A shoulder 78 defined by a radially extending lip 76 on the valve plate 74 engages an upper surface 96 of an upwardly projecting portion 98 of the rim 104. An O-ring 48 is mounted in a circumferential groove 24 on the cylindrical portion 54 of the valve plate 74 and engages the inside surface of the rim 104 to seal the valve plate 74 to the filter head 14. An inwardly extending flange 22 on the valve plate 74 has an upper surface 140 that is engaged by the spring 68. The spring 68 exerts a biasing force on the valve plate 74 to hold it in place.

The valve plate 74 has a flange 22 which defines an opening 36 which receives a primer valve 122, and a plurality of radially spaced valve orifices 52 which collectively define a primer outlet 20. The primer valve 122 has a ball valve seat 34 and a sealing member 50 extending radially way from the ball valve seat 34. The ball valve opening 36 in the flange 22 is substantially coaxial with the first fuel conduit 94 and second fuel conduit 100. The inner edge of the flange 22 is received by a circumferential groove 146 on the primer valve 122 to mount and seal the primer valve 122 to the valve plate 74. The radially extending sealing member 50 of the primer valve 122 is movable between an upper position (shown) and a lower position such that the sealing member 50 closes the valve orifices 52 when it is in the upper position. When in the lower position, the sealing member 50 opens the valve orifices 52 to provide fluid communication between the primer reservoir 28 and the outlet plenum 134. The sealing member 50 and the ball valve seat 34 may be a monolithic unit made of a singular piece, or they may be separate pieces attached by any suitable means. The valve ball seat 34 and/or the sealing member 50 may be made out of a variety of suitable materials, but is preferably made of buna-nitrile, Dupont Viton® or any other resilient material sufficient for achieving functionality herein.

The primer inlet 18 is provided by valve plate 74 and more particularly a ball cage 38 thereof discussed below. The valve plate 74 and primer valve 122 together form an inlet check valve in the form of a ball check valve 32. As may be understood from the above description of sealing member 50 and orifices 52, sealing member 50 and valve plate 74 together form an outlet check valve in the form of a flapper check valve. Although The ball valve 32 is formed by ball cage 38, valve seat 34, and a valve ball 40 movable between the ball valve ball cage 38 and valve seat 34. Valve ball 40 may be made of buna-nitrile, Dupont Viton®, polypropylene or any other material sufficient for achieving functionality herein

A stepped bore 120, containing upper and lower portions 124, 126, extends axially through the body of the primer valve 122, and more particularly valve seat 34, and defines a ball valve opening 138. The inside diameter of the upper portion 124 of the bore 120 is greater than the inside diameter of the lower portion 126 to define the shoulder region 128 of the ball valve seat 34.

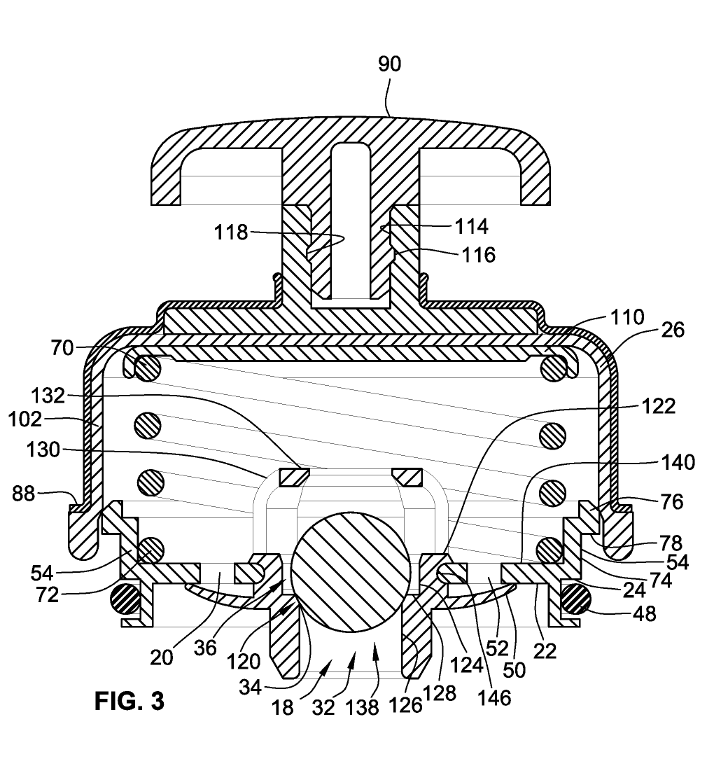

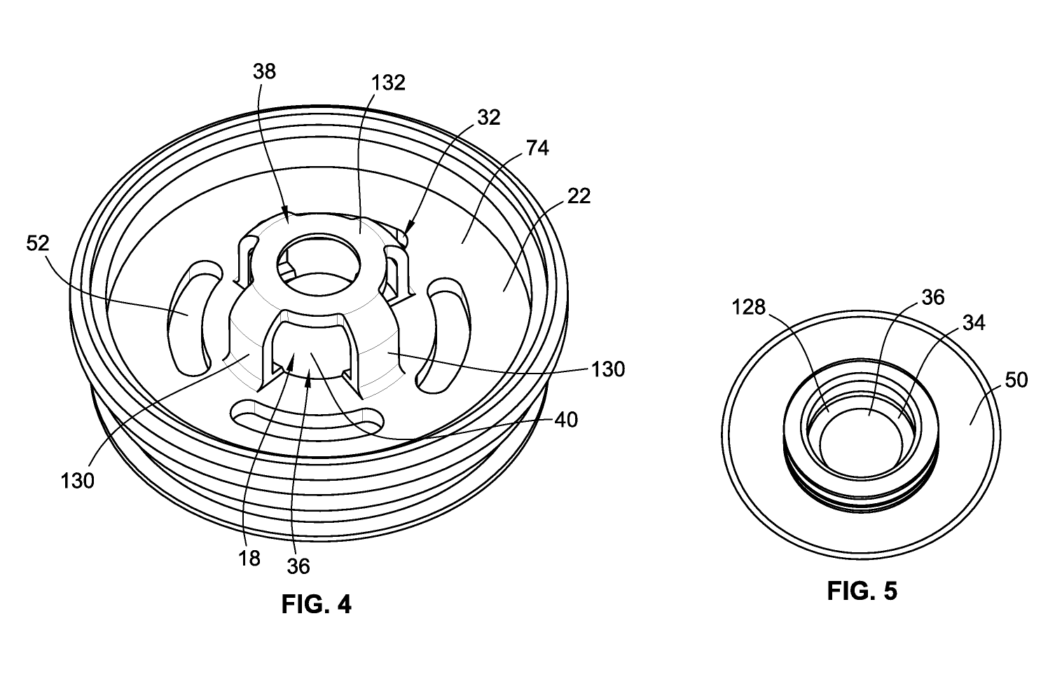

As shown in FIGS. 3-4, a plurality of radially spaced retaining members 130 protrude from the upper surface of the valve plate 74 to form the ball cage 38 by meeting centrally above the opening 36 and the ball valve opening 138, which may form a cage ring 132. In one embodiment, four retaining members are used, but it will be recognizes more than four or less than four retaining members may be used. The ball cage 38 and the valve plate 74 may be made a monolithic unit or may be separate parts attached by any suitable method. The ball cage 38 and valve plate 74 may be made out of a variety of appropriate materials, but is preferably made out of glass filled nylon, or Polybutylene Terephthalate (PBT), or any other suitable lightweight rigid material. Alternatively, the ball cage 38 may be made of a mesh material (not shown) protruding from the upper surface of the valve plate 74 and meeting above the upper surface of the valve plate 74 to form a cage. Any structure may be utilized as a ball cage such that it traps or constrains the movement of valve ball 40 to effectuate the operation herein.

The valve ball 40 may be seated on the ball valve seat 34 within the ball cage 38. More specifically, the valve ball 40 may seat against an edge provided by lower portion 126 of stepped bore 120. The valve ball 40 may travel axially between the ball cage 38 and the edge of lower portion 126 of stepped bore 120 up to 5.5 millimeters as one example. It will be recognized however, that in other embodiments the valve ball 40 may be allowed to travel more or less than 5.5 millimeters. When the valve ball 40 is in a lower position it is seated on the ball valve seat 34 as shown to prevent or reduce flow through the ball valve opening 36. When the valve ball 40 is in an upper position it is retained by the ball cage 38. In the upper position, the valve ball uncovers the ball valve opening 36, and fluid communication is provided between the primer reservoir 28, ball valve opening 36, and the interior chamber 64.

The filter assembly 10 is primed by depressing the hand knob 90, plunger 82, and diaphragm 26 against the spring 68. The pressure created by depressing the diaphragm 26 pushes the valve ball 40 into the ball valve seat 34, closing the ball valve opening 36. The pressure pushes the sealing member 50 into a lower position, opening the valve orifices 52 in the flange 22 to expel fuel and air in the filter assembly 10 via the outlet plenum 134 and fuel exit port 58. Upon release of the hand knob 90, the spring 68 returns the diaphragm 26 to the expanded position, creating suction in the primer reservoir 28. This suction draws closed the sealing member 50, sealing the valve orifices 52 in the flange 22 and opening the ball valve opening 36. The suction draws fuel from the fuel entry port 60, through the second fuel conduit 100 and interior chamber 64 and then into the primer reservoir 28 via the first fuel conduit 94.

The size of the present invention may be scaled up or down as is necessary. The diaphragm 26 preferably has a diameter of about 30 millimeters to about 60 millimeters, and the primer mechanism when actuated has a stroke length of about 5 millimeters to about 15 millimeters when the hand knob depresses the spring into contracted position. The ball valve 32 and the valve orifices 52 in the primer inlet 20 each define an open flow area of 50 square millimeters, but may be larger if necessary. This design is advantageous over previous designs in that the inlet check valve does not require restrictive umbrella supports. The additional structure added by using umbrella supports decreases the open flow area of the valve, thereby increasing the pressure drop through the primer assembly. The flow restriction of previous designs also contributes negatively filter life, an effect that can be lessened by the present invention.

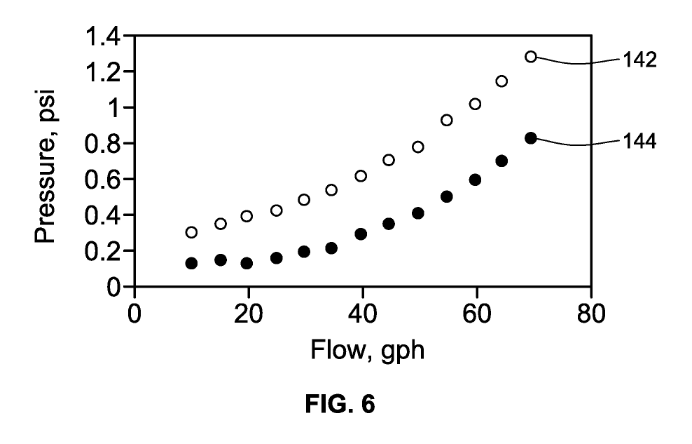

FIG. 6 shows the pressure drop as a function of flow rate as tested for an embodiment of the present invention as compared to a conventional primer assembly utilizing a restrictive umbrella valve. As shown, at consistent flow rates, the filter assembly tested using a primer mechanism of the present invention 144 created less of a pressure drop as compared to the filter tested using a conventional valve design 142. This is a result of the increased inlet flow area due to the removal of the umbrella supports utilized in the conventional primer assembly.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A primer assembly, comprising:
a primer support body providing a primer inlet and a primer outlet;
an inlet check valve in the primer support body having an open position allowing flow through the primer inlet and a closed position blocking flow through the primer inlet;
an outlet check valve in the primer support body having an open position allowing flow through the primer outlet and a closed position blocking flow through the primer outlet;
a diaphragm supported by the primer support body and defining a reservoir for fluid, the primer inlet connecting to the reservoir through the inlet check valve, the primer outlet connecting to the reservoir through the outlet check valve;
an actuator acting upon the diaphragm, wherein movement of the actuator expands and contracts the reservoir; and
wherein one of the inlet check valve and the outlet check valve comprises a ball valve.

2. The primer assembly of claim 1, wherein a ball valve provides the inlet check valve, wherein the ball valve comprises:
a valve seat defining a valve opening connected to the primer inlet port;
a ball cage projecting axially from and surrounding the valve seat; and
a valve ball seated upon the valve seat in the closed position of the inlet check valve and trapped within the ball valve by the ball cage.

3. The primer assembly of claim 2, further comprising a spring interposed between said actuator and said primer support body.

4. The primer assembly of claim 2, wherein the ball cage further comprises a plurality of retaining members.

5. The primer assembly of claim 4, wherein the ball cage is comprised of four retaining members.

6. The primer assembly of claim 4, wherein the retaining members meet at a ring above the valve seat.

7. The primer assembly of claim 2, wherein the valve ball is made of one of buna-nitrile, Dupont Viton®, or polypropylene.

8. The primer assembly of claim 2, wherein the outlet check valve is sealed by a sealing member.

9. The primer assembly of claim 8, wherein the valve seat and sealing member are a monolithic unit.

10. The primer assembly of claim 9, wherein the valve seat and outlet check valve are made of one of buna-nitrile or Dupont Viton®.

11. (canceled)

12. The primer assembly of claim 2, wherein an outlet for the outlet check valve and an inlet for the inlet check valve are defined by a valve plate.

13. The primer assembly of claim 12, wherein the valve plate and the ball cage are monolithic unit.

14. The primer assembly of claim 13, wherein the valve plate and ball cage are made of one of glass filled nylon or PBT.

15. The primer assembly of claim 2, wherein a counterbore is formed in the valve seat.

16. The primer assembly of claim 15, wherein the counterbore provides an edge against which the valve ball seats.

17. The primer assembly of claim 2, wherein the diaphragm has a diameter of 30 millimeters to 60 millimeters and wherein each of the inlet and outlet check valves define an open flow area of at least 50 square millimeters.

18-33. (canceled)

34. A filter head and filter assembly, comprising:
a filter head having a filter head base having an inlet passageway and an outlet passageway;
a filter for filtering fluid, the filter mounted to the filter head base for receiving unfiltered fluid from the inlet passageway and returning filtered fluid toward the outlet passageway;
a primer assembly coupled to the filter head base and providing a connecting passageway from the filter to the outlet passageway;
a primer support body providing a primer inlet and a primer outlet, the connecting passageway passing through the primer inlet and the primer outlet;
an inlet check valve in the primer support body having an open position allowing flow through the primer inlet and a closed position blocking flow through the primer inlet;
an outlet check valve in the primer support body having an open position allowing flow through the primer outlet and a closed position blocking flow through the primer outlet;
a diaphragm supported by the primer body and defining a reservoir for fluid, the primer inlet connecting to the reservoir through the inlet check valve, the primer outlet connecting to the reservoir through the outlet check valve;
an actuator acting upon the diaphragm, wherein movement of the actuator expands and contracts the reservoir; and
wherein the diaphragm has a diameter of 30 millimeters to 60 millimeters, and wherein each of the first and second check valves define an open flow area of at least 50 square millimeters.

35. The filter head and filter assembly of claim 34, wherein a ball valve provides the inlet check valve, wherein the ball valve comprises:
a valve seat defining a valve opening connected to the primer inlet port;
a ball cage projecting axially from and surrounding the valve seat; and
a valve ball seated upon the valve seat in the closed position of the inlet check valve and trapped within the ball valve by the ball cage.

36. The filter head and filter assembly of claim 35, further comprising a spring interposed between said actuator and said primer support body.

37. The filter head and filter assembly of claim 35, wherein the ball cage further comprises a plurality of retaining members.

38. The filter head and filter assembly of claim 37, wherein the ball cage is comprised of four retaining members.

39. The filter head and filter assembly of claim 37, wherein the retaining members meet at a ring above the valve seat.

40. The filter head and filter assembly of claim 35, wherein the valve ball is made of one of buna-nitrile, Dupont Viton®, or polypropylene.

41. The filter head and filter assembly of claim 35, wherein the outlet check valve is sealed by a sealing member.

42. The filter head and filter assembly of claim 41, wherein the valve seat and sealing member are a monolithic unit.

43. The filter head and filter assembly of claim 42, wherein the valve seat and outlet check valve are made of one of buna-nitrile or Dupont Viton®.

44. (canceled)

45. The filter head and filter assembly of claim 35, wherein an outlet for the outlet check valve and an inlet for the inlet check valve are defined by a valve plate.

46. The filter head and filter assembly of claim 45, wherein the valve plate and the ball cage are monolithic unit.

47. The filter head and filter assembly of claim 46, wherein the valve plate and ball cage are made of one of glass filled nylon or PBT.

48. The filter head and filter assembly of claim 35, wherein a counterbore is formed in the valve seat.

49. The filter head and filter assembly of claim 48, wherein the counterbore provides an edge against which the valve ball seats.

50-65. (canceled)
